(19) United States
(12) Patent Application Publication
(10) Pub. No.: US 2013/0156659 A1
(43) Pub. Date: Jun. 20, 2013

(54) DEVICE FOR STORING CRYO-GRID STORAGE BOXES

(71) Applicants: Nicola Gerardo Antonio Abrescia, Derio (ES); David Gil Carton, Derio (ES); Carles Chalaux, Derio (ES)

(72) Inventors: Nicola Gerardo Antonio Abrescia, Derio (ES); David Gil Carton, Derio (ES); Carles Chalaux, Derio (ES)

(73) Assignees: ASOCIACION CENTRO DE INVESTIGACION COOPERATIVA EN BIOCIENCIAS-CIC bioGUNE, DERIO (ES); FUNDACION IKERBASQUE, BILBAO (ES)

(21) Appl. No.: 13/696,588

(22) PCT Filed: May 6, 2011
(86) PCT No.: PCT/EP2011/057266

§ 371 Date: Jan. 14, 2013

(30) Foreign Application Priority Data
May 7, 2010 (EP) 10162229.8

(51) Int. Cl. B01L 9/00

(52) U.S. Cl. CPC B01L 9/523
USPC 422/561

(57) ABSTRACT

A device for storing a plurality of cryo-grid storage boxes in a dewar, comprising a substantially cylindrical body having a diameter, wherein said diameter is such that the device fits substantially exactly in a dewar canister, and said cylindrical body comprises a plurality of storage holes, the cross-sectional dimensions of the storage holes being adapted to a standard-size cryo-grid storage box such that each storage hole fits at least one standard-size cryo-grid storage box.

In the field of cryo-electron microscopy, frozen samples are investigated using an electron microscope. Generally copper cryo-grids are used, in which a 3-4 microliter sample may be deposited. Such samples may be quickly flash-frozen using liquid ethane. Eventually, such a cryo-grid is positioned in an electron microscope to investigate the sample.

It may be necessary to store a plurality of these cryo-grids for a short or longer period of time before they can be investigated. If samples cannot be safely stored and/or may degrade at room-temperature or at around 4 degrees, the samples and the corresponding cryo-grids may need to be stored under cryogenic conditions. It is known to use cryo-grid storage boxes that include a plurality of cryo-grids. These cryo-grid storage boxes are then stored in dewars containing liquid nitrogen, so as to make sure the (e.g. biological) samples stay frozen during storage.

Normally, a cryo-grid storage box is introduced into an adapted vial or container such as for example a so-called Falcon tube. Such a vial or Falcon tube is then stored in a dewar for example using a thin cord. Although this may be a practical way to store a smaller number of cryo-grid storage boxes, problems can arise when a larger number of cryo-grid storage boxes needs to be stored for a prolonged period of time. Each vial (or Falcon tube) occupies a space that is much larger than a cryo-grid storage box, and a dewar may fill up quickly when using a plurality of vials. This may mean that more dewars or larger dewars need to be used. Another problem that may occur is that with a plurality of vials (or Falcon tubes), it may not be straightforward to trace each sample.

US 2002/0084277 discloses a shipping container holding a dewar vessel. The dewar vessel has an inner vessel that holds a specimen chamber. Vials containing samples can be introduced into a cartridge, which is placed in a bag. The bag is then lowered into the specimen chamber.

U.S. Pat. No. 4,745,771 discloses a sample holder for the cryo-preparation of biological tissue samples. A sample holder can be introduced in to a sample chamber. The sample chamber further includes a resin containing chamber, an ultra high vacuum valve and tubulation to provide access to the resin into the sample chamber. Support members are used to maintain the relative spacing between the tubulation and the sample chamber. The whole is then introduced into a dewar. As a result, the storage of biological samples is quite inefficient in its use of dewar space.

U.S. Pat. No. 4,712,607 discloses a cryo-cell assembly for biological material including a space for receiving the material, the space being at least partly enclosed by means suitable for conducting heat from the space to a heat sink and including heat generating means in heat conducting relationship with the space. Power is applied to the heat generating means according to a desired temperature cycle stored in a memory. A cryo-cell assembly includes an inner core member and an outer member separated by a thermally insulating material. Straws (2 mm) containing biological material are introduced into the inner core member. One of the straws contains a temperature sensor. The whole of the cryo-cell assembly is introduced into a flask of liquid nitrogen. Also this system is inefficient in its use of cryogenic storage space.

There thus exists a need for a device that is suitable for storing cryo-grids with samples to be investigated using cryo-electron microscopy which can help to reduce the need for dewar storage space. There also exists a need for such a device which can be easily handled using conventional and commercially available laboratory tools. There furthermore exists a need for a device which may facilitate the tracking and/or identification of individual samples.

An aspect of the present developments may include at least partially fulfilling one or more of these needs.

In a first aspect, the developments may provide a device for storing a plurality of cryo-grid storage boxes in a dewar, that may include a cylindrical body having a diameter, wherein said diameter is such that the device fits in a dewar canister, and said cylindrical body includes a plurality of storage holes, the dimensions of the storage holes being such that each storage hole fits at least one standard-size cryo-grid storage box.

A plurality of ordinary, commercially available cryo-grid storage boxes may thus be introduced into the plurality of storage holes provided in a cylindrical body. The diameter of the cylindrical body may be such that it substantially exactly fits in a standard size dewar canister. This way, a plurality of samples may be stored in an efficient manner.

In some implementations, the cylindrical body may include nine storage holes. However, other numbers of storage holes may be used. The ideal number of storage holes may depend e.g. on the size and shape of the cryo-grid storage boxes used in a laboratory.

In some implementations, the depth of at least one storage hole is such that two or more cryo-grid storage boxes may be stored on top of each other. Each hole may thus include more than one cryo-grid storage box stacked on at least one other storage box. Each storage hole may thus e.g. be used to store cryo-grid storage boxes with similar samples, or samples from the same “owner”.

In some implementations, an identifier may be provided in proximity to each storage hole. An identifier may be used to identify an “owner” of a certain sample, or to identify an individual sample. The identifier may include e.g. a number or a letter, or a symbol. In these implementations, a plurality of samples from different owners may thus be stored in a single cylindrical body, and each sample still may be identified easily. The identifiers may be either removably attached to the storage device, or they may be formed integrally with the cylindrical body.

In some implementations, the storage holes in the cylindrical body may have a circular cross-section. The dimensions and shape of the holes may be adapted to commercially available circular cryo-grid storage boxes. In other implementations, the storage holes may have a square cross-section and be adapted to the size of commercially available square cryo-grid storage boxes.

In some implementations, at least one storage hole may have different dimensions or a different shape than one other hole. Such a device may thus be used to store cryo-grid storage boxes of different shapes.

In some implementations, the cylindrical body may furthermore have a pin by which the body may be handled. Using commercially available tweezers, clamps or similar conventional tools, the device may thus be easily introduced into a canister. Several or a unique indentation in the pin may be provided along the pin to facilitate these operations. Said canister may then be used to lower the samples into a dewar. When wanting to retrieve a sample, the canister may be used to lift the device out of the dewar. Using the pin, the device can be easily retrieved from the canister.

Optionally, said cylindrical body may include a central recess and said pin is provided in said central recess. Optionally, said plurality of storage holes may be provided around said central recess.

Particular implementations of the present developments will be described in the following, only by way of non-limiting examples, with reference to the appended drawings, in which:

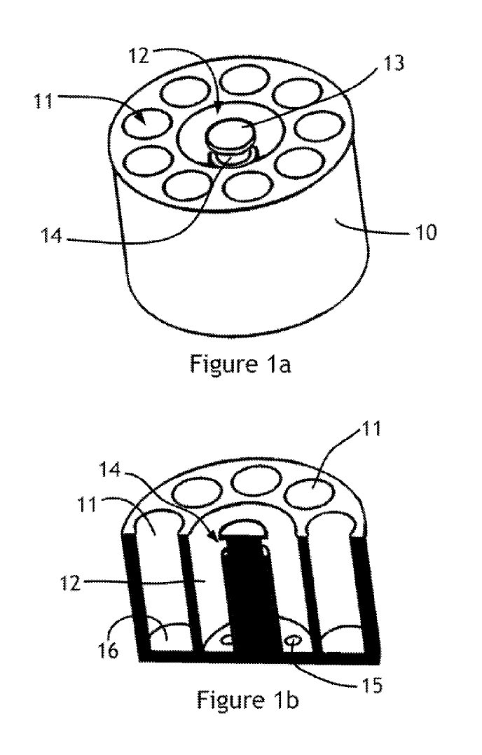

FIG. 1 which includes sub-part FIGS. 1a and 1 b illustrates a first implementation of a storage device according to the present developments;

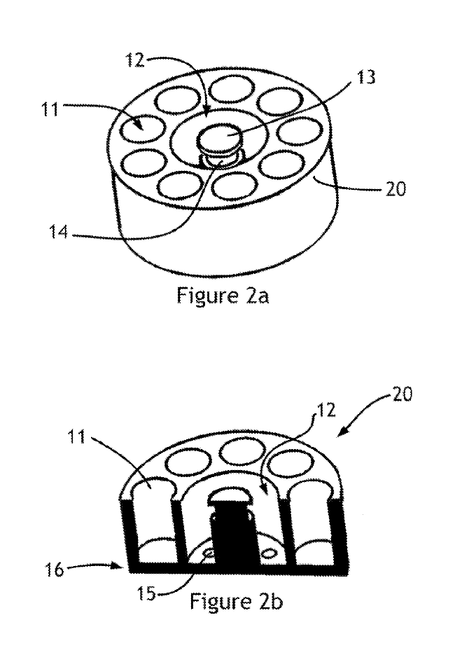

FIG. 2 which includes sub-part FIGS. 2a and 2b illustrates a second implementation of a storage device according to the present developments;

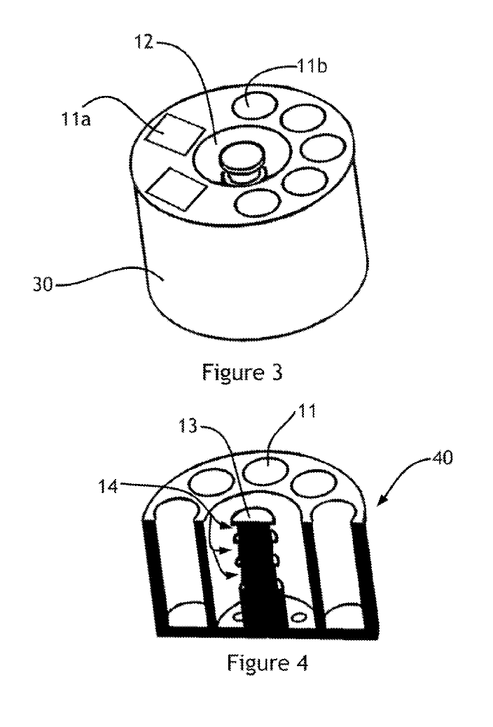

FIG. 3 illustrates a further implementation of a storage device according to the present developments;

FIG. 4 illustrates yet a further implementation of a storage device according to the present developments;

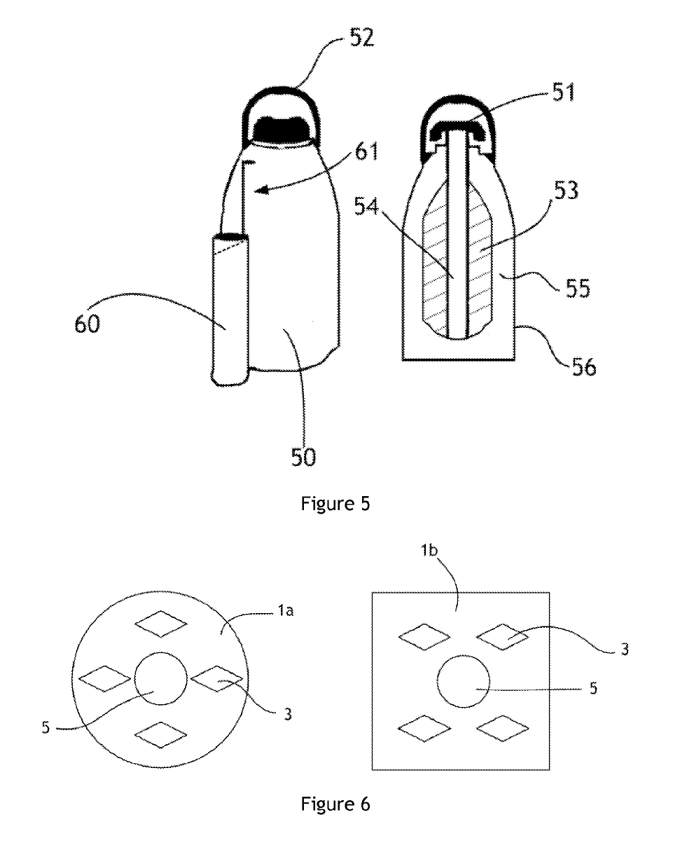

FIG. 5 shows an isometric view and a cross-sectional view of a dewar which may be used in combination with implementations of the present developments;

FIG. 6 shows top views of two commercially available cryo-grid storage boxes which may be used advantageously in combination with implementations of the present developments.

FIG. 1a illustrates a first implementation of a storage device 10. This storage device 10 may have, as shown, nine holes 1 1 of suitable dimensions such that each hole fits a commercially available cryo-grid storage box. Cryo-grid storage boxes are known of various dimensions and various shapes.

It is convenient for cryo-grid storage boxes if they can be handled automatically using robot machinery or other standardized electron microscopy laboratory equipment. The storage boxes therefore may generally be of standardized dimensions. For example, Tedpella™ commercially offers circular cryo-grid storage boxes. Each storage box is able to contain four (cryo-grids with corresponding) samples which may need to be studied using electron microscopy.

An example of a circular cryo-grid storage box is shown in FIG. 6. Storage box 1a has, as shown, four receptacles 3 in which a sample may be introduced. The storage box 1 a may further include a protruding part 5, which may e.g. be a bolt, screw or pin. Such a bolt 5 may be adapted to be handled using laboratory equipment such as a magnetic handling rod, tweezers, clamps or other. Preferably, bolt 5 may be magnetic which makes the storage boxes particularly easy to handle using e.g. a magnetic rod. Cryo-grid storage boxes of this type are both known with and without a top lid.

Such a circular storage box may have a diameter of approximately 13 mm and a height of approximately 7 mm (including the head of the screw or bolt 5); Storage holes 11 of the device are adapted to such a standard sized storage box, and may have a diameter of approximately 14 mm. It will be clear that a slightly different diameter may also be used; the diameter of the storage hole may be determined such that they are able to receive and contain a storage box, and allows easy introduction and extraction. If a much larger diameter is chosen, less cryo-grid storage boxes may be stored in the device, reducing the efficiency of the solution.

The device further may include a recess 12, in which a pin 13 is provided. Such a pin 13 may facilitate handling of the device using conventional laboratory tools, such as e.g. tweezers, clamps, or tongs. To further facilitate this handling, an indentation 14 may be provided.

FIG. 1 b shows a cross-sectional view of device 10 according to FIG. 1a. Bottom 16 of device 10 includes a plurality of through-holes 15, such that upon introduction in a dewar, liquid nitrogen can pass through these holes and fill up the device.

In the implementation of FIG. 1a, the depth of the hole may be e.g. approximately 40 mm. This way, a plurality of cryo-grid storage boxes (for example one to four storage boxes) may be stacked within each hole 11. In this implementation, the device 10 may store e.g. thirty-six cryo-grid storage boxes. Compared to using individual vials (or Falcon-tubes), the required space is significantly reduced, and the use of dewars in laboratories may be optimized. It will be clear that the height of the storage device 10 and depth of storage holes 11 may be varied in accordance with circumstances.

Although not shown in FIG. 1, an identifier may be provided in the proximity of each of the storage holes. Such an identifier may e.g. include numbers or letters. Such identifiers may help to be able to distinguish between various samples e.g. belonging to different providers, or belonging to different people working in the same laboratory and using the same equipment.

FIGS. 2a and 2b show an isometric view and a cross-sectional view of a second implementation of a storage device according to the present developments. The difference between the implementation of FIG. 2 and the implementation of FIG. 1 is that the height of the device 20 is smaller. Also, the depth of holes 11 is reduced as compared to the previous implementation. Instead of three or four circular storage-boxes, only two storage boxes can be stacked in each storage hole. On the other hand, more storage devices can be stacked within a canister and stored within the same dewar. Also in this implementation, a pin 13 having an indentation 14 is provided in a recess 12. Also, through-holes 15 are provided in a central part of the bottom 16.

FIG. 3 illustrates a further implementation of a storage device according to the present developments. Storage device 30 may include storage holes 1 1 a adapted to fit one or more rectangular storage boxes and storage holes 1 1 b adapted to fit one or more circular storage boxes. Once again, a central recess 12 is provided with a pin. In this implementation, two rectangular storage holes 11 a and five circular storage holes are provided. In other implementations, the ratio of rectangular and circular storage holes could be different. In yet further implementations, only rectangular holes could be provided.

FIG. 6 shows a top view of an example of a rectangular cryo-grid storage box commercially available from Tedpella™. A cryo-grid storage box 1 b may include a plurality of apertures 3 in which samples may be introduced. Cryo-grid storage boxes of this type are also both known with and without a top lid. The length and width of such a rectangular storage box may be approximately 13×13 mm. The corresponding dimensions of storage hole 11 b may be approximately 14×14 mm. It will be clear that slightly different dimensions may also be used, as long as a storage box can be easily introduced, stored and extracted. Choosing too large dimensions will reduce the efficiency of the storage device.

FIG. 4 illustrates a storage device 40 of similar configuration as FIG. 1. However, three indentations 14 are provided along the pin 13. The plurality of indentations may further facilitate the handling of the device using ordinary laboratory equipment, e.g. tweezers. In the implementations shown so far, indentations were provided along a pin provided in a central recess. However, in other implementations, a central pin may be provided with one or more annular protrusions instead of indentations. In alternative implementations, the central recess may be provided e.g. with annular rims to facilitate handling. In yet further implementations, no central pin or recess is provided and instead the device is foreseen of e.g. a magnetic portion which may facilitate handling. In yet other implementations, the device may include a central threaded hole for handling with a tool having a mating thread.

FIG. 5 shows an isometric view and a cross-sectional view of a commercially available dewar 50 for storing samples in liquid nitrogen. Also shown in FIG. 5 is a canister 60 which may be used to insert samples into and extract samples from dewar 50. Dewars 50 may generally include a handle 51, a lid 52 and an exterior high-strength metal body with a central tubular opening 54. Around said tubular opening 54, adsorption material 53 may be provided. Between the adsorption material and housing 56, a vacuum 55 may be established. Using such a construction, samples can be effectively stored in liquid nitrogen and heat transfer either through transmission, convection or conduction is avoided. Such dewars are commercially available from e.g. Taylor-Wharton Cryogenics™.

In use of the device, one or more storage devices according to the present developments may be introduced into a canister 60. Such a storage device is adapted to fit substantially exactly in said canister. The diameter of the storage device may be e.g. approximately 65 mm. For ease of introduction, a top part of a canister may be adjusted by a diagonal cut (as schematically indicated with an interrupted line in FIG. 5). In other implementations of the developments hereof, the diameter of the cylindrical body of the storage device may be reduced slightly so as to facilitate its introduction in a canister.

Canister 60 fits substantially exactly in tubular opening 54 of dewar 50 filled with liquid nitrogen. When a sample stored in a cryo-grid storage box is to be examined, canister 60 may be removed from dewar 50; one or more storage devices can be extracted from the canister using e.g. tweezers. Subsequently, a cryo-grid with deposited sample thereon may be taken from the storage device.

Although the developments hereof have been disclosed in the context of certain preferred implementations and examples, it will be understood by those skilled in the art that the present developments extend beyond the specifically disclosed implementations to other alternative implementations and/or uses of the developments and obvious modifications and equivalents thereof. Thus, it is intended that the scope of the present developments herein disclosed should not be limited by the particular disclosed implementations described before, but should be determined only by a fair reading of the claims that follow.

1. A device for storing a plurality of cryo-grid storage boxes in a dewar, comprising
a substantially cylindrical body having a diameter, wherein
said diameter is such that the device fits substantially exactly in a canister of the dewar, and
said cylindrical body comprises a plurality of storage holes, the cross-sectional dimensions of the storage holes being adapted to a standard-size cryo-grid storage box such that each storage hole fits at least one standard-size cryo-grid storage box.

2. A device according to claim 1, wherein said cylindrical body comprises nine storage holes.

3. A device according to claim 1, wherein the depth of at least one storage hole is such that two or more cryo-grid storage boxes may be stored on top of each other.

4. A device according to claim 1, wherein an identifier is provided in proximity of each storage hole.

5. A device according to claim 2, wherein one or more of said storage holes have a circular cross-section.

6. A device according to claim 1, wherein one or more of said storage holes have a square cross-section.

7. A device according to claim 1, wherein at least one storage hole has different dimensions or a different shape than one other storage hole.

8. A device according to claim 1, wherein said body furthermore comprises a pin by which the body may be handled.

9. A device according to claim 8, wherein said cylindrical body comprises a central recess and said pin is provided in said central recess.

10. A device according to claim 9, wherein said pin comprises one or more indentations to facilitate its handling.

11. A device according to claim 9, wherein said plurality of holes is provided around said central recess.

12. A device according to claim 9, wherein the bottom along a portion of said central recess comprises one or more through-holes.

13. A device according to claim 1, wherein the cylindrical body comprises one or more through-holes.

14. A device according to claim 5, wherein the storage holes of circular cross-section have a diameter of approximately 14 mm.

15. A device according to claim 14, wherein the depth of the storage holes is such that each storage holes fits four circular cryo-grid storage boxes on top of each other.

16. A device according to claim 6, wherein the storage holes of square cross-section have a length and width of approximately 14 mm.

17. A device according to claim 1, wherein the cylindrical body further comprises a threaded hole by which the body may be handled.

18. A device according to claim 2, wherein the cylindrical body has a diameter of approximately 65 mm.
